(19) United States
(12) Patent Application Publication
(10) Pub. No.: US 2023/0028526 A1
(43) Pub. Date: Jan. 26, 2023

(54) ANTENNA DEVICE

(71) Applicant: SAMSUNG ELECTRO-MECHANICS CO., LTD., Suwon-si (KR)

(72) Inventors: Nam Ki KIM, Suwon-si (KR); Hokyung KANG, Suwon-si (KR); Hyungho SEO, Suwon-si (KR); Hong-In KIM, Suwon-si (KR); Kyubum HAN, Suwon-si (KR)

(73) Assignee: SAMSUNG ELECTRO-MECHANICS CO., LTD., Suwon-si (KR)

(21) Appl. No.: 17/574,854

(22) Filed: Jan. 13, 2022

(30) Foreign Application Priority Data
Jul. 13, 2021 (KR) 10-2021-0091619

(51) Int. Cl. H01Q 25/00; H01Q 1/48

(52) U.S. Cl. CPC H01Q 25/002; H01Q 1/48

(57) ABSTRACT

An antenna device includes a ground plane, a first feed via and a second feed via for penetrating the ground plane through a first hole and a second hole of the ground plane, a first feed pattern connected to the first feed via, a first antenna pattern configured to be coupled to the first feed pattern and transmit/receive an RF signal of a first frequency bandwidth, a second antenna pattern connected to the second feed via and configured to transmit/receive an RF signal of a second frequency bandwidth, and a third antenna pattern disposed between the first antenna pattern and the second antenna pattern, and overlapping the first antenna pattern and the second antenna pattern.

### CROSS-REFERENCE TO RELATED APPLICATIONS

This application claims the benefit under 35 USC 119(a) of Korean Patent Application No. 10-2021-0091619 filed in the Korean Intellectual Property Office on Jul. 13, 2021, the entire disclosure of which is incorporated herein by reference for all purposes.

### BACKGROUND

### 1. Field

The present disclosure relates to an antenna device.

### 2. Description of the Background

Recently, millimeter wave (mmWave) communication including 5th generation (5G) communication has been actively researched, and studies for commercializing/standardizing an antenna device for fluently realizing it is also actively progressing.

Radio Frequency (RF) signals with high frequency bandwidths, for example, 24 GHz, 28 GHz, 36 GHz, 39 GHz, and 60 GHz may be easily lost while they are transmitted, and the signals may be lost by a collision with harmonic components of the RF signals in low frequency bandwidths. Therefore, quality of communication may be deteriorated.

In another way, as portable electronic devices are developed, the size of the screen that is a display area of the electronic device becomes bigger, and the size of a bezel that is a non-display area in which an antenna is disposed is reduced, such that the area of the region in which the antenna may be installed is also reduced.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna device includes a ground plane, a first feed via and a second feed via for penetrating the ground plane through a first hole and a second hole of the ground plane, a first feed pattern connected to the first feed via, a first antenna pattern configured to be coupled to the first feed pattern and transmit/receive an RF signal of a first frequency bandwidth, a second antenna pattern connected to the second feed via and configured to transmit/receive an RF signal of a second frequency bandwidth, and a third antenna pattern disposed between the first antenna pattern and the second antenna pattern, and overlapping the first antenna pattern and the second antenna pattern.

The antenna device may further include a first dielectric layer disposed between the first feed pattern and the first antenna pattern, a second dielectric layer disposed between the first antenna pattern and the third antenna pattern, a third dielectric layer disposed between the third antenna pattern and the second antenna pattern, a first connection via penetrating through the first dielectric layer and connected to the second feed via, a first connection pattern connected to the first connection via and disposed on the first dielectric layer, a second connection via connected to the first connection pattern and penetrating through the second dielectric layer, a second connection pattern connected to the second connection via and disposed on the second dielectric layer, and a third connection via connected to the second connection pattern and the second antenna pattern and penetrating through the third dielectric layer.

The antenna device may further include a plurality of shield vias disposed between the first feed via and the second feed via.

The antenna device may further include a ground via penetrating through a center portion of the first antenna pattern and connected to the ground plane.

The antenna device may further include a metal pattern disposed on the third dielectric layer and connected to the ground via.

The second antenna pattern may include a hole in a center portion of the second antenna pattern, and the metal pattern may be disposed in the hole of the second antenna pattern.

The antenna device may further include a plurality of first parasitic patterns disposed on a side of an edge of the second antenna pattern, wherein the first parasitic patterns do not overlap the first antenna pattern in a first direction from the ground plane to the first antenna pattern.

The antenna device may further include a plurality of second parasitic patterns disposed on a side of an edge of the third antenna pattern, wherein the second parasitic patterns overlap the first parasitic patterns in the first direction.

An antenna array may include array antenna devices disposed in an array, and one or more shielding structures disposed at one or more of a first end of the array, a second end of the array, and alternately with two or more antenna array devices, wherein one or more of the array antenna devices is the antenna device.

An electronic device may include a set of the electronic device, and the antenna array disposed on the set of the electronic device.

In another general aspect, an antenna device includes an antenna unit, and a main circuit unit connected to the antenna unit through a connector. The antenna unit includes a plurality of first dielectric layers, a ground plane disposed below the first dielectric layers, a first feed via and a second feed via penetrating a portion of the first dielectric layers, a first antenna pattern disposed between the first dielectric layers and coupled to the first feed via to transmit/receive an RF signal of a first frequency bandwidth, a second antenna pattern disposed between the first dielectric layers and connected to the second feed via to transmit/receive an RF signal of a second frequency bandwidth, and a third antenna pattern disposed between the first antenna pattern and the second antenna pattern and overlapping the first antenna pattern and the second antenna pattern. The main circuit unit includes a plurality of second dielectric layers, and metal layers disposed between the second dielectric layers. A loss tangent of the first dielectric layers is different from a loss tangent of the second dielectric layers.

The first dielectric layers may include a first dielectric layer disposed between the first feed pattern and the first antenna pattern, a second dielectric layer disposed between the first antenna pattern and the third antenna pattern, and a third dielectric layer disposed between the third antenna pattern and the second antenna pattern. The antenna unit may further include a first connection via penetrating through the first dielectric layer and connected to the second feed via, a first connection pattern connected to the first connection via and disposed on the first dielectric layer, a second connection via connected to the first connection pattern and penetrating through the second dielectric layer, a second connection pattern connected to the second connection via and disposed on the second dielectric layer, and a third connection via connected to the second connection pattern and the second antenna pattern and penetrating through the third dielectric layer.

In another general aspect, an antenna device includes a first feed via connected to a first feed pattern, a first antenna pattern disposed above the first feed pattern and configured to be coupled to the first feed pattern, a second antenna pattern disposed above the first antenna, connection vias connected to second and third feed vias, stepped apart from each other in two or more steps along connection patterns toward the second antenna pattern, and connected to the second antenna pattern, and a third antenna pattern disposed between the first and second antenna patterns.

The antenna device may further include shield vias disposed between the first feed via and the second and third feed vias.

The antenna device may further include a ground via connected to a center portion of the first antenna pattern and connected to a ground plane.

The antenna device may further include a metal pattern disposed on a same dielectric layer as the second antenna and connected to the ground via.

Other features and aspects will be apparent from the following detailed description, the drawings, and the claims.

### BRIEF DESCRIPTION OF THE DRAWINGS

FIG. 1 shows a cross-sectional view of an antenna device according to one or more embodiments.

FIG. 2 shows a top plan view of part of an antenna device of FIG. 1 according to one or more embodiments.

FIG. 3 shows a top plan view of part of an antenna device of FIG. 1 according to one or more embodiments.

FIG. 4 shows a top plan view of part of an antenna device of FIG. 1 according to one or more embodiments.

FIG. 5 shows a top plan view of part of an antenna device of FIG. 1 according to one or more embodiments.

FIG. 6 shows a top plan view of part of an antenna device of FIG. 1 according to one or more embodiments.

FIG. 7 shows a cross-sectional view of part of an antenna device of FIG. 1 according to one or more embodiments.

FIG. 8 shows a cross-sectional view of an antenna device according to one or more other embodiments.

FIG. 9 shows a top plan view of an antenna array according to one or more embodiments.

FIG. 10 shows a cross-sectional view of an antenna array according to one or more embodiments.

FIG. 11 shows a top plan view of part of an antenna device according to one or more embodiments.

FIG. 12 shows an exploded view of an antenna device according to one or more embodiments.

FIG. 13 shows an electronic device including an antenna device according to one or more embodiments.

FIG. 14 shows a graph on results of an experimental example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The phrase “in a plan view” means viewing an object portion from the top, and the phrase “in a cross-sectional view” means viewing a cross-section of which the object portion is vertically cut from the side.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The embodiments described herein disclose a multi-bandwidth antenna device for improving performance and allowing down-sizing.

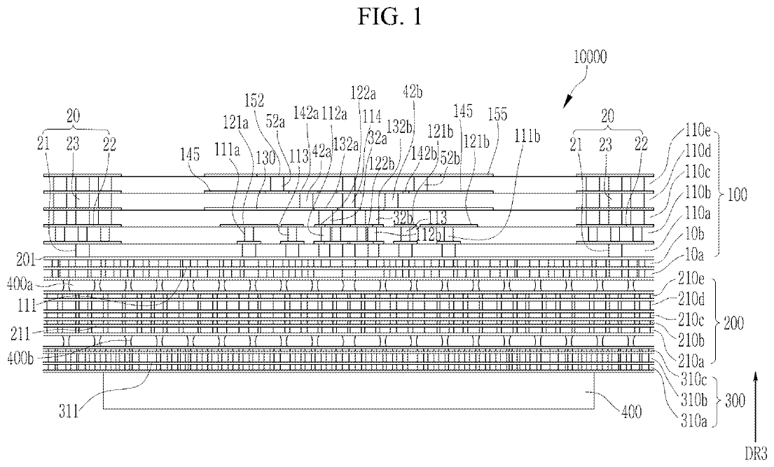

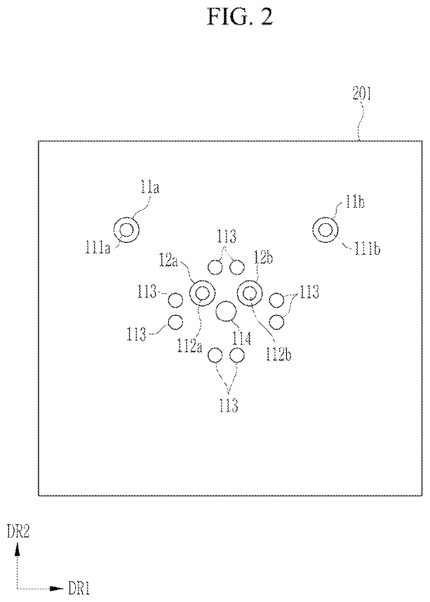

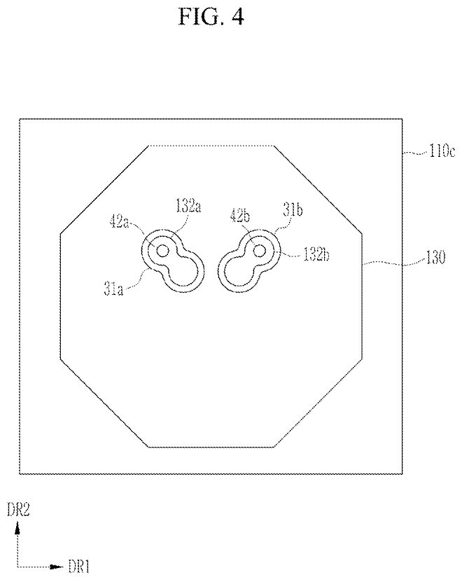

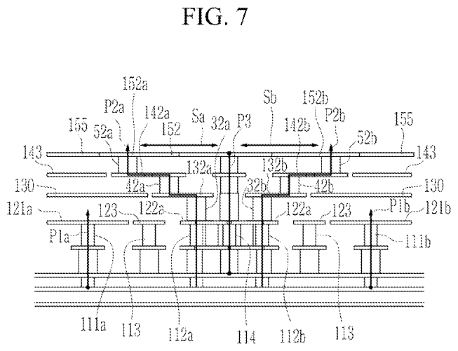

An antenna device according to one or more embodiments will now be described with reference to FIG. 1 to FIG. 7. FIG. 1 shows a cross-sectional view of an antenna device according to one or more embodiments, FIG. 2 to FIG. 6 show top plan views of part of one or more embodiments of an antenna device of FIG. 1, and FIG. 7 shows a cross-sectional view of part of an antenna device of FIG. 1 according to one or more embodiments.

Referring to FIG. 1, the antenna device 10000 according to one or more embodiments may include an antenna unit 100, a main circuit unit 200, and a radio frequency-system in package (RF-SiP) 300. The antenna unit 100 may be electrically connected to the main circuit unit 200 through a first connector 400a, and the RF-SiP 300 may be electrically connected to the main circuit unit 200 through a second connector 400b. The first connector 400a and the second connector 400b may be a solder ball, a pin, a land, a pad, or a solder on pad (SOP).

The antenna unit 100 of the antenna device 10000 may include: a wire layer 10 (10a, 10b); a plurality of first dielectric layers 110a, 110b, 110c, 110d, and 110e disposed on the wire layer 10 (10a, 10b); a ground plane 201 disposed between the wire layer 10 and the first dielectric layers 110a, 110b, 110c, 110d, and 110e; a plurality of feed vias 111a, 111b, 112a, and 112b; a plurality of vias 113 and 114; a first feed pattern 121a; a second feed pattern 121b; a plurality of metal patterns 122a, 122b, 123, and 124; a first connection via 32a; a second connection via 32b; a first antenna pattern 130; a first connection pattern 132a; a second connection pattern 132b; a third connection via 42a; a fourth connection via 42b; second antenna patterns 143 and 144; a third connection pattern 142a; a fourth connection pattern 142b; a fifth connection via 52a; a sixth connection via 52b; a fourth antenna pattern 152; and a plurality of shield structures 20.

The main circuit unit 200 of the antenna device 10000 includes a plurality of second dielectric layers 210a, 210b, 210c, 210d, and 210e, and a plurality of metal layers 211 disposed between the second dielectric layers 210a, 210b, 210c, 210d, and 210e.

The RF-SiP 300 of the antenna device 10000 includes a plurality of third dielectric layers 310a, 310b, and 310c, and a plurality of metal layers 311 disposed between the third dielectric layers 310a, 310b, and 310c.

A structure of the antenna unit 100 of the antenna device 10000 according to the present embodiment will now be described in detail with reference to FIG. 2 to FIG. 6 together with FIG. 1.

The wire layer 10 of the antenna unit 100 includes a first wire layer 10a and a second wire layer 10b, a plurality of metal layers 111 are disposed on the first wire layer 10a and the second wire layer 10b, and the ground plane 201 is disposed on the second wire layer 10b.

Referring to FIG. 1 and FIG. 2, the ground plane 201 extends in a first direction DR1 and a second direction DR2, and the ground plane 201 may have a first hole 11a, a second hole 11b, a third hole 12a, and a fourth hole 12b.

The first feed via 111a and the second feed via 111b may be connected to the wire layer 10 through the first hole 11a and the second hole 11b of the ground plane 201, and a third feed via 112a and a fourth feed via 112b may be connected to the wire layer 10 through the third hole 12a and the fourth hole 12b of the ground plane 201. The first feed via 111a and the second feed via 111b may receive a first RF signal through the wire layer 10, and the third feed via 112a and the fourth feed via 112b may receive a second RF signal through the wire layer 10.

The first RF signal may have a first frequency bandwidth, the second RF signal may have a second frequency bandwidth, and the first frequency bandwidth may be different from the second frequency bandwidth.

The vias 113, and 114 may be disposed on the ground plane 201, and the vias 113 and 114 may include a plurality of shield vias 113 and a ground via 114.

The third feed via 112a and the fourth feed via 112b may be nearer a center of the antenna than the first feed via 111a and the second feed via 111b are, and the shield vias 113 may be nearer the third feed via 112a and the fourth feed via 112b than the first feed via 111a and the second feed via 111b are.

The ground via 114 may be disposed in the center of the antenna. The shield vias 113 may be disposed to make pairs by two and surround the ground via 114, may be disposed to be symmetric with respect to the ground via 114 in the first direction DR1, and may be disposed to be symmetric in the second direction DR2.

The shield vias 113 and the ground via 114 may be connected to the ground plane 201.

The first feed via 111a, the second feed via 111b, the third feed via 112a, the fourth feed via 112b, the shield vias 113, and the ground via 114 may penetrate the first layer 110a and the second layer 110b of the first dielectric layers 110a, 110b, 110c, 110d, and 110e in a third direction DR3 that is perpendicular to the first direction (DR1) and the second direction (DR2). The third direction DR3 may go toward the first antenna pattern 130 from the ground plane 201.

The first dielectric layers 110a, 110b, 110c, 110d, and 110e may include a plurality of layers made of a prepreg dielectric material of which a dielectric constant is about 3 to 4 and a loss tangent is about 0.003 to about 0.004, but they are not limited thereto. In the first dielectric layers 110a, 110b, 110c, 110d, and 110e, the second layer 110b may be thicker than the first layer 110a, the third layer 110c, the fourth layer 110d, and the fifth layer 110e, but it is not limited thereto.

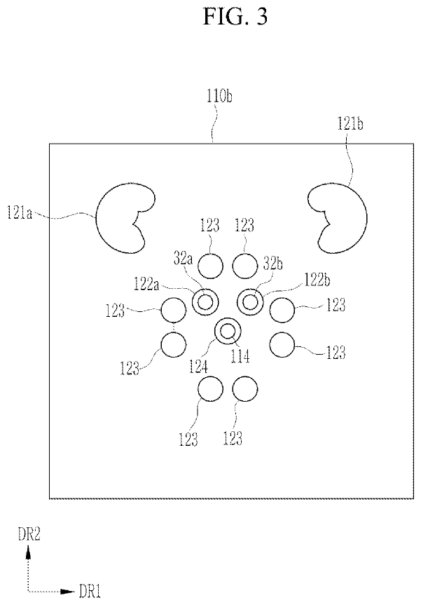

Referring to FIG. 3 together with FIG. 1 and FIG. 2, a plurality of feed patterns 121a and 121b and a plurality of metal patterns 122a, 122b, 123, and 124 may be disposed on the second layer 110b of the first dielectric layers 110a, 110b, 110c, 110d, and 110e.

The feed patterns 121a and 121b include a first feed pattern 121a connected to a first feed via 111a and a second feed pattern 121b connected to the second feed via 111b. The first feed pattern 121a may have a C shape extending in a counterclockwise direction, and the second feed pattern 121b may have a reverse C shape extending in a clockwise direction. However, the shapes of the first feed pattern 121a and the second feed pattern 121b are not limited thereto, and may have various planar forms.

The first pattern 122a and the second pattern 122b of the plurality of metal patterns 122a, 122b, 123, and 124 are connected to the third feed via 112a and the fourth feed via 112b, the plurality of third patterns 123 of the plurality of metal patterns 122a, 122b, 123, and 124 are connected to the plurality of shield vias 113, and the fourth pattern 124 of a plurality of metal patterns 122a, 122b, 123, and 124 is connected to the ground via 114.

The first connection via 32a and the second connection via 32b are disposed on the first pattern 122a and the second pattern 122b, and the first connection via 32aand the second connection via 32b are connected to the third feed via 112a and the fourth feed via 112b through the first pattern 122a and the second pattern 122b. The ground via 114 may be additionally disposed on the fourth pattern 124.

Referring to FIG. 1 to FIG. 3 and FIG. 4, the first antenna pattern 130, the first connection pattern 132a, and the second connection pattern 132b are disposed on the third layer 110c of the first dielectric layers 110a, 110b, 110c, 110d, and 110e.

The first antenna pattern 130 may be coupled to the first feed pattern 121a and the second feed pattern 121b to receive electric signals from the first feed via 111a and the second feed via 111b.

The first antenna pattern 130 may have a polygonal shape in a plan view, for example, an octagon. The first feed pattern 121a and the second feed pattern 121b may be disposed to overlap two edges of the first antenna pattern 130 in parallel to the third direction DR3.

The first antenna pattern 130 may have a fifth hole 31a and a sixth hole 31b, and the first connection pattern 132a and the second connection pattern 132b may be disposed in the fifth hole 31a and the sixth hole 31b of the first antenna pattern 130. The first connection pattern 132a and the second connection pattern 132b may be spaced from the first antenna pattern 130 through the fifth hole 31a and the sixth hole 31b.

The first connection pattern 132a and the second connection pattern 132b may be disposed on the first connection via 32a and the second connection via 32b to be connected to the first connection via 32a and the second connection via 32b, and a third connection via 42a and a fourth connection via 42b may be disposed on the first connection pattern 132a and the second connection pattern 132b.

The ground via 114 may be disposed in a center portion of the first antenna pattern 130. The ground via 114 may include a portion disposed below the first antenna pattern 130 and a portion disposed above the first antenna pattern 130.

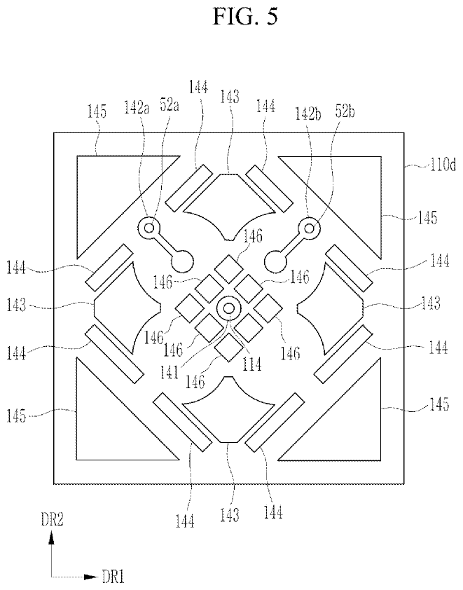

Referring to FIG. 5 together with FIG. 1 to FIG. 4, a plurality of second antenna patterns 143 and 144, a plurality of third antenna patterns 145, a third connection pattern 142a, a fourth connection pattern 142b, and a plurality of metal patterns 141 and 146 are disposed on the fourth layer 110d of the first dielectric layers 110a, 110b, 110c, 110d, and 110e.

A fifth connection via 52a and a sixth connection via 52b are disposed on the third connection pattern 142a and the fourth connection pattern 142b.

A plurality of sixth patterns 146 of the metal patterns 141 and 146 may be disposed to surround a fifth pattern 141 of the metal patterns 141 and 146. The ground via 114 is additionally disposed on the fifth pattern 141.

A plurality of second sub-patterns 144 may be made pairs and may be disposed on respective both sides of a plurality of first sub-patterns 143 of the second antenna patterns 143 and 144.

The second antenna patterns 143 and 144 may overlap the first antenna pattern 130 in a direction parallel to the third direction DR3, and each of the first sub-pattern 143 and the two second sub-patterns 144 disposed on respective sides of the first sub-pattern 143 of the second antenna patterns 143 and 144 may be disposed at a top, a bottom, a right, and a left with respect to the antenna.

The third antenna patterns 145 are disposed on four corners, and at least part of the third antenna patterns 145 may not overlap the first antenna pattern 130 in the direction parallel to the third direction DR3. The third antenna pattern 145 may have a polygonal shape in a plan view, for example, it may have a right triangular shape, and a right corner of the right triangle may be disposed on the corner portion of the antenna unit 100.

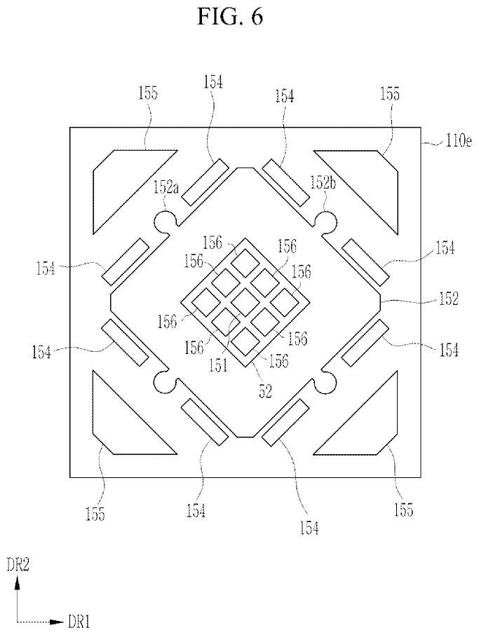

Referring to FIG. 6 together with FIG. 1 to FIG. 5, a fourth antenna pattern 152, and a plurality of fifth antenna patterns 154, a plurality of sixth antenna patterns 155, and a plurality of metal patterns 151 and 156 disposed around edges of the fourth antenna pattern 152, are disposed on the fifth layer 110e of the first dielectric layers 110a, 110b, 110c, 110d, and 110e.

The fourth antenna pattern 152 may include a first extension 152a and a second extension 152b, and the first extension 152a and the second extension 152b of the fourth antenna pattern 152 may be connected to the fifth connection via 52a and the sixth connection via 52b.

The fourth antenna pattern 152 may be connected to the third feed via 112a and the fourth feed via 112b through the fifth connection via 52a and the sixth connection via 52b connected to the first extension 152a and the second extension 152b, the third connection pattern 142a and the fourth connection pattern 142b connected to the fifth connection via 52a and the sixth connection via 52b, the third connection via 42a and the fourth connection via 42b connected to the third connection pattern 142a and the fourth connection pattern 142b, the first connection pattern 132a and the second connection pattern 132b connected to the third connection via 42a and the fourth connection via 42b, and the first connection via 32a and the second connection via 32b connected to the first connection pattern 132a and the second connection pattern 132b and may receive electric signals from the third feed via 112a and the fourth feed via 112b.

The fourth antenna pattern 152 may overlap the first sub-patterns 143 in the direction parallel to the third direction DR3, the fifth antenna patterns 154 may overlap the second sub-patterns 144, and the sixth antenna patterns 155 may overlap the third antenna patterns 145.

The metal patterns 151 and 156 may overlap the metal patterns 141 and 146 in the direction parallel to the third direction DR3.

The seventh pattern 151 of the metal patterns 151 and 156 is connected to the ground via 114 and applies a ground signal to the center of the antenna. The eighth patterns 156 of the metal patterns 151 and 156 may be disposed to surround the seventh pattern 151.

A method for an antenna unit 100 of an antenna device 10000 according to one or more embodiments to transmit/receive RF signals will now be described with reference to FIG. 7 together with FIG. 1 to FIG. 6.

The first antenna pattern 130 may be coupled to the first feed pattern 121a connected to the first feed via 111a to transmit/receive a first RF signal of first polarization on a first path (P1a), and may be coupled to the second feed pattern 121b connected to the second feed via 111b to transmit/receive a first RF signal of second polarization on a second path (P1b). The first polarization may be horizontal polarization, and second polarization may be vertical polarization.

The shield via 113 and the ground via 114 are connected to the ground plane 201. The ground via 114 may be connected to the first antenna pattern 130 and connects the ground plane 201 and the first antenna pattern 130 to thus shield the third feed via 112a and the fourth feed via 112b from the signals transmitted/received to/from the first antenna pattern 130.

The first connection pattern 132a and the second connection pattern 132b connected to the third feed via 112a and the fourth feed via 112b penetrate the first antenna pattern 130 and are connected to the fourth antenna pattern 152 disposed on the first antenna pattern 130, and the shield vias 113 reduce influences caused by propagation of the first RF signal focusing on the first antenna pattern 130 to reduce the influence between the first antenna pattern 130 and the fourth antenna pattern 152, and hence, degradation of an antenna gain by interference between the first antenna pattern 130 and the fourth antenna pattern 152 may be reduced.

The eight shield vias 113 have been exemplified in the present embodiment, and without being limited thereto, a number and a width of the shield vias are not specifically limited. When a gap between the shield vias is shorter than a specific length, for example, a length that is dependent on a first wavelength of the first RF signal or a length that is dependent on a second wavelength of the second RF signal, the first RF signal or the second RF signal may not substantially pass through a space between the shield vias, and hence, electromagnetic isolation between the first and second RF signals may be further improved.

The second antenna patterns 143 and 144 may be additionally coupled to the first antenna pattern 130. The second antenna patterns 143 and 144 may be coupled to the fourth antenna pattern 152, the fifth antenna patterns 154, and the sixth antenna patterns 155.

The fourth antenna pattern 152 may be connected to the third feed via 112a and the fourth feed via 112b through the fifth connection via 52a and the sixth connection via 52b connected to the first extension 152a and the second extension 152b, the third connection pattern 142a and the fourth connection pattern 142b connected to the fifth connection via 52a and the sixth connection via 52b, the third connection via 42a and the fourth connection via 42b connected to the third connection pattern 142a and the fourth connection pattern 142b, the first connection pattern 132a and the second connection pattern 132b connected to the third connection via 42a and the fourth connection via 42b, and the first connection via 32a and the second connection via 32b connected to the first connection pattern 132a and the second connection pattern 132b, and may transmit/receive the second RF signal of first polarization and the second RF signal of second polarization from the third feed via 112a and the fourth feed via 112b through the third path (P2a) and the fourth path (P2b). The first polarization may be horizontal polarization, and the second polarization may be vertical polarization.

The fifth antenna patterns 154 are disposed along the edge of the fourth antenna pattern 152, so the fifth antenna patterns 154 are coupled to the fourth antenna pattern 152 and may increase the bandwidth of the second RF signal. The sixth antenna patterns 155 may be parasitic patterns that are disposed near the fourth antenna pattern 152, are additionally coupled to the fourth antenna pattern 152 and the fifth antenna patterns 154, and increase the bandwidth of the second RF signal.

As described, as the sixth antenna patterns 155 disposed along the edge of the fourth antenna pattern 152 are included, an area of the fourth antenna pattern 152 is not increased, and the bandwidth of the second RF signal transmitted/received through the fourth antenna pattern 152 may be increased, thereby increasing performance of the antenna unit 100 without increasing the area of the antenna unit 100.

The fourth antenna pattern 152 has a seventh hole 52 disposed in the center portion. The seventh hole 52 may have a polygonal shape, for example, a rhombus shape in a plan view. As the fourth antenna pattern 152 flows by detouring the seventh hole 52 disposed in the center portion, a surface current flowing to the fourth antenna pattern 152 may flow with an electrical length that is greater than a physical length of the fourth antenna pattern 152. Therefore, the bandwidth of the second RF signal transmitted/received by the fourth antenna pattern 152 may be increased.

The ground signal is transmitted to the central portion of the first antenna pattern 130 on a fifth path P3 through the ground via 114 connected to the central portion of the first antenna pattern 130, so the first antenna pattern 130 may function as a ground plane for reflecting the electric signal of the fourth antenna pattern 152.

The second antenna patterns 143 and 144 overlap the fourth antenna pattern 152 in the direction parallel to the third direction DR3, so the second antenna patterns 143 and 144 may function as a reflector of the second RF signal transmitted/received by the fourth antenna pattern 152. The third antenna patterns 145 overlap the sixth antenna patterns 155 in the direction parallel to the third direction DR3, and the sixth antenna patterns 155 may function as a reflector of the second RF signal transmitted/received by the fourth antenna pattern 152 as a parasitic patch.

As the seventh pattern 151 disposed on the center portion of the antenna unit 100 and connected to the ground via 114 is included and the ground signal is applied to the center portion of the antenna unit 100 through the fifth path P3, isolations (Sa and Sb) between the second RF signal of first polarization transmitted/received to/from the fourth antenna pattern 152 through the third feed via 112a and the second RF signal of second polarization transmitted/received to/from the fourth antenna pattern 152 through the fourth feed via 112b may be additionally increased.

According to the antenna device according to an embodiment, the first antenna pattern 130 for transmitting/receiving the first RF signal is disposed on the third layer 110c of the first dielectric layers 110a, 110b, 110c, 110d, and 110e, the fourth antenna pattern 152 for transmitting/receiving the second RF signal is disposed on the fifth layer 110e of the first dielectric layers 110a, 110b, 110c, 110d, and 110e, and the second antenna patterns 143 and 144 are disposed between the first antenna pattern 130 and the fourth antenna pattern 152 to relatively increase the gap between the first antenna pattern 130 and the fourth antenna pattern 152, and increase isolation between the first antenna pattern 130 for transmitting/receiving the first RF signal and the fourth antenna pattern 152 for transmitting/receiving the second RF signal.

The second antenna patterns 143 and 144 are disposed between the first antenna pattern 130 and the fourth antenna pattern 152, so the second antenna patterns 143 and 144 may be coupled to the first antenna pattern 130, and may simultaneously function as a reflector of the second RF signal transmitted/received through the fourth antenna pattern 152.

By connecting the ground via 114 to the center portion of the first antenna pattern 130 and applying the ground signal to the center portion of the first antenna pattern 130, the first antenna pattern 130 may function as a ground layer for the second RF signal transmitted/received through the fourth antenna pattern 152.

The fourth antenna pattern 152 transmits/receives the second RF signal through the first connection via 32a and the second connection via 32b, the first connection pattern 132a and the second connection pattern 132b, the third connection via 42a and the fourth connection via 42b, the third connection pattern 142a and the fourth connection pattern 142b, and the fifth connection via 52a and the sixth connection via 52b sequentially connected from bottom to top and from the antenna center portion to the edge from the third feed via 112a and the fourth feed via 112b.

As described, spaced distances between the first and second feed vias 111a, 111b and the third and fourth feed vias 112a, 112b are obtained, and a gap between the first extension 152a and the second extension 152b of the fourth antenna pattern 152 to which the fifth connection via 52a and the sixth connection via 52b are connected may be increased, so the isolation between the second RF signal of first polarization transmitted/received through the third feed via 112a and the second RF signal of second polarization transmitted/received through the fourth feed via 112b may be increased. By including the seventh pattern 151 position on the center portion of the antenna unit 100 and connected to the ground via 114, the isolation between the second RF signal of first polarization transmitted/received to/from the fourth antenna pattern 152 through the third feed via 112a and the second RF signal of second polarization transmitted/received to/from the fourth antenna pattern 152 through the fourth feed via 112b may be additionally increased.

The fourth antenna pattern 152 may have a seventh hole 52 disposed at the center portion, may have an electrical length of a surface current flowing to the fourth antenna pattern 152, may increase the bandwidth of the second RF signal transmitted/received by the fourth antenna pattern 152, and may include a plurality of sixth antenna patterns 155 disposed along the edge of the fourth antenna pattern 152, thereby increasing the bandwidth of the second RF signal transmitted/received through the fourth antenna pattern 152 without increasing an area of the fourth antenna pattern 152, so performance of the antenna unit 100 may be increased without increasing the area of the antenna unit 100.

The third antenna patterns 145 disposed below the sixth antenna patterns 155 and overlapping the sixth antenna patterns 155 in the direction parallel to the third direction DR3 are further included, thereby allowing the same to function as a reflector of the RF signal transmitted/received through the sixth antenna patterns 155 and increasing performance of the antenna.

The first RF signal has a first frequency bandwidth, and the second RF signal has a second frequency bandwidth. For example, the first frequency bandwidth may be about 24.25 GHz to about 29.5 GHz, the center frequency of the first frequency bandwidth may be about 28 GHz, the second frequency bandwidth may be about 37 GHz to about 40 GHz, and the center frequency of the second frequency bandwidth may be about 39 GHz.

Referring to FIG. 1, the shield structures 20 are disposed near the antenna unit 100, and include a first via 21, a plurality of second vias 22, and a plurality of patterns 23. The patterns 23 are disposed among the first dielectric material layers 110a, 110b, 110c, 110d, and 110e, and are electrically connected to the ground plane 201 through the first via 21 and the second vias 22. Accordingly, the shield structures 20 may prevent interference among the antenna units 100 that are disposed near each other, and a gain of the antenna device 10000 may be increased.

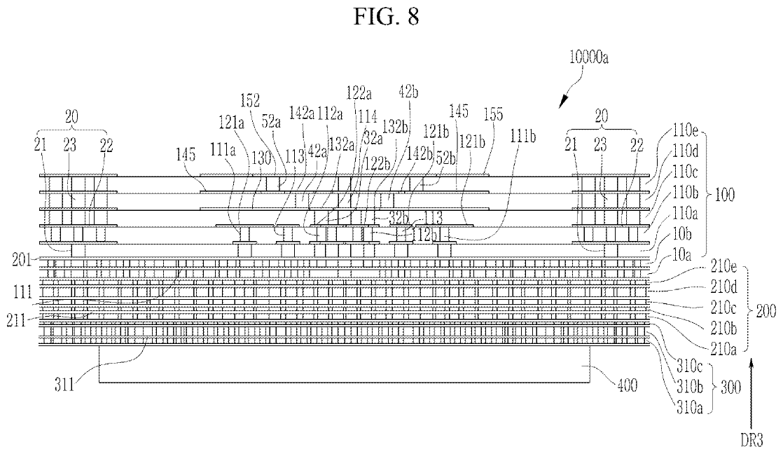

An antenna device 10000a according to one or more other embodiments will now be described with reference to FIG. 2 to FIG. 7 together with FIG. 8.

The antenna device 10000a according to the present embodiment is similar to the antenna device 10000 according to an embodiment described with reference to FIG. 1 to FIG. 7. No same constituent elements will be described further.

Differing from the antenna device 10000 according to an embodiment described with reference to FIG. 1 to FIG. 7, regarding the antenna device 10000a according to the present embodiment, the main circuit unit 200 and the antenna unit 100 may be sequentially disposed in the third direction DR3, and the first connector 400a may not be disposed between the antenna unit 100 and the circuit unit 200. The antenna device 10000a according to the present embodiment may include a radio frequency-system in package (RF-SiP) 300 disposed below the main circuit unit 200 in the third direction DR3, and the second connector 400b may not be disposed between the main circuit unit 200 and the RF-SiP 300.

That is, the circuit unit 200 and the antenna unit 100 of the antenna device 10000a according to the present embodiment may be sequentially formed on the same substrate.

The antenna unit 100 of the antenna device 10000a according to the present embodiment may have substantially the same structure as the antenna unit 100 of the antenna device 10000 according to an embodiment described with reference to FIG. 1 to FIG. 7.

Many characteristics of the antenna unit 100 of the antenna device 10000 according to an embodiment described with reference to FIG. 1 to FIG. 7 are applicable to the antenna unit 100 of the antenna device 10000a according to the present embodiment.

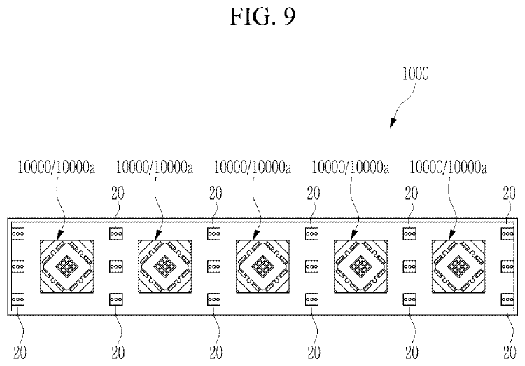

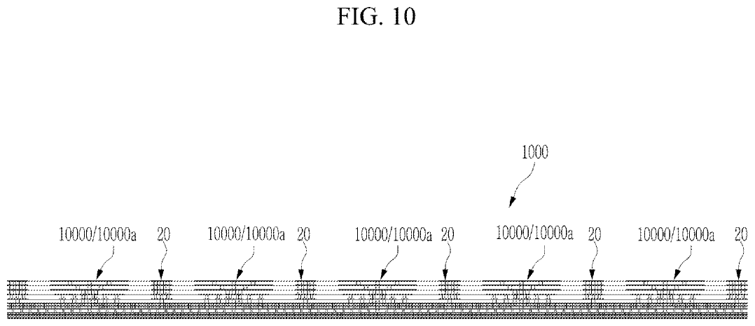

An antenna array 1000 including the above-described antenna device 10000 will now be described with reference to FIG. 9 and FIG. 10. FIG. 9 shows a top plan view of an antenna array according to one or more embodiments, and FIG. 10 shows a cross-sectional view of an antenna array according to one or more embodiments.

Referring to FIG. 9 and FIG. 10, the antenna array 1000 includes a plurality of antenna devices 10000 or 10000a. The respective antenna devices 10000 or 10000a may be the antenna device 10000 according to an embodiment described with reference to FIG. 1 to FIG. 7 or the antenna device 10000a according to an embodiment described with reference to FIG. 8. No further detailed descriptions of the antenna devices 10000 or 10000a will be provided.

A plurality of shield structures 20 are disposed among the antenna devices 10000 or 10000a. The shield structures 20 may prevent interference among the antenna devices 10000 or 10000a, thereby increasing the gain of the antenna array.

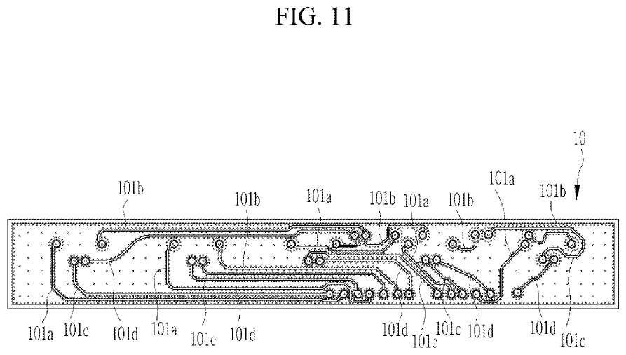

A signal wire of the wire layer 10 of the antenna devices 10000 or 10000a according to an embodiment will now be described in detail with reference to FIG. 11. FIG. 11 shows a top plan view of part of an antenna device according to one or more embodiments.

Referring to FIG. 11, a plurality of signal wires 101a, 101b, 101c, and 101d may be formed on the wire layer 10 of the antenna devices 10000 or 10000a according to the above-described embodiments, and electric signals may be applied to a plurality of first feed vias 111a, second feed vias 111b, third feed vias 112a, and fourth feed vias 112b through the signal wires 101a, 101b, 101c, and 101d.

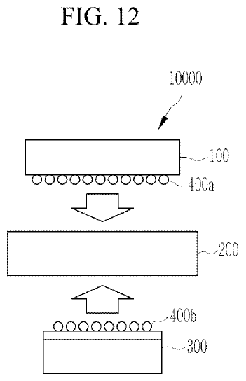

A connection relationship of the antenna device 10000 according to an embodiment described with reference to FIG. 1 to FIG. 7 will now be described with reference to FIG. 12. FIG. 12 shows an exploded view of an antenna device 10000 according to one or more embodiments.

Referring to FIG. 12, the antenna device 10000 according to an embodiment includes an antenna unit 100, a main circuit unit 200, and a radio frequency-system in package (RF-SiP) 300.

The antenna unit 100, the main circuit unit 200, and the RF-SiP 300 are individually formed, the antenna unit 100 may be electrically connected to the main circuit unit 200 through the first connector 400a, and the RF-SiP 300 may be electrically connected to the main circuit unit 200 through the second connector 400b. The first connector 400a and the second connector 400b may be a solder ball, a pin, a land, a pad, or a solder on pad (SOP).

As described above, the antenna unit 100 and the main circuit unit 200 are individually formed, and the antenna unit 100 is electrically connected to the main circuit unit 200 through the first connector 400a, so the first dielectric layers 110a, 110b, 110c, 110d, and 110e of the antenna unit 100 may include insulation layers with a relatively small loss tangent value, and the second dielectric layers 210a, 210b, 210c, 210d, and 210e of the main circuit unit 200 may include insulation layers with a relatively big loss tangent value. For example, the loss tangent that is a dissipation factor of the first dielectric layers 110a, 110b, 110c, 110d, and 110e of the antenna unit 100 may be about 0.003 to about 0.004 at 10 GHz, and the loss tangent of the second dielectric layers 210a, 210b, 210c, 210d, and 210e of the main circuit unit 200 may be about 0.02 to about 0.03 at 10 GHz.

The third dielectric layers 310a, 310b, and 310c of the RF-SiP 300 of the antenna device 10000 may include insulation layers with a relatively small loss tangent value.

The antenna unit 100 may be formed to include a substrate including a low-loss insulation layer with a relatively small loss tangent value which is relatively expensive and may reduce energy loss of the antenna unit 100, and the main circuit unit 200 may be formed to include a substrate including an insulation layer with a relatively big loss tangent value which is relatively inexpensive, and they are connected to each other, thereby maintaining performance of the antenna unit 100 and reducing a manufacturing cost of the antenna device 10000.

The antenna unit 100 may be attached to the desired position of the main circuit unit 200 to thus increase the freedom of designing, compared to the case in which the antenna unit 100 and the main circuit unit 200 are formed on one substrate.

The antenna unit 100 is electrically connected to the main circuit unit 200 through the first connector 400a, so heat may be radiated through the first connector 400a and performance of heat radiation of the antenna device 10000 may be increased.

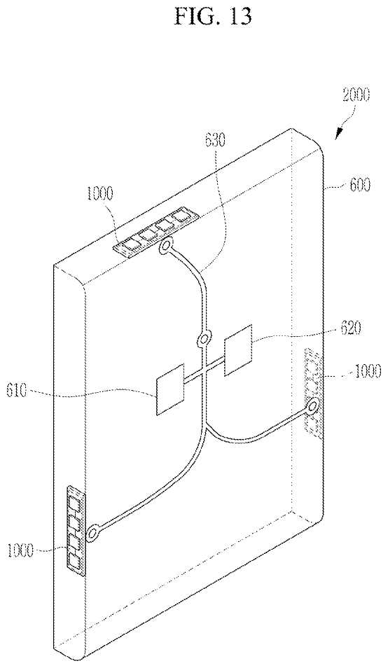

An electronic device including an antenna device according to one or more embodiments will now be described with reference to FIG. 13. FIG. 13 shows an electronic device including an antenna device according to one or more embodiments.

Referring to FIG. 13, the electronic device 2000 according to an embodiment includes the antenna array 1000 described with reference to FIG. 9 and FIG. 10, and the antenna array 1000 is disposed on a set 600 of the electronic device 2000.

The electronic device 2000 may be a smart phone, a personal digital assistant, a digital video camera, a digital still camera, a network system, a computer, a monitor, a tablet, a laptop, a netbook, a television, a video game, a smart watch, and an automotive part, and it is not limited thereto.

The electronic device 2000 may have sides of a polygon, and the antenna array 1000 may be disposed near at least some of a plurality of sides of the electronic device 2000.

A communication module 610 and a baseband circuit 620 may be further disposed on the set 600. The antenna device may be connected to the communication module 610 and/or the baseband circuit 620 through a coaxial cable 630.

The communication module 610 may include at least some of a memory chip such as a volatile memory (e.g., a DRAM), a non-volatile memory (e.g., a ROM), or a flash memory; an application processor chip such as a central processor (e.g., a CPU), a graphic signal processor (e.g., a GPU), a digital signal processor, an encoding processor, a microprocessor, and a microcontroller; and a logic chip such as an analog-digital converter or an application-specific IC (ASIC) for the purpose of performing digital signal processing.

The baseband circuit 620 may generate a base signal by performing an analog-digital conversion, and amplifying, filtering, and frequency-converting the analog signal. The base signal input/output by the baseband circuit 620 may be transmitted to the antenna device through a cable.

For example, the base signal may be transmitted to the IC through an electrical connection structure, a core via, and a wire. The IC may convert the base signal into an RF signal in the millimeter wave (mmWave) bandwidth.

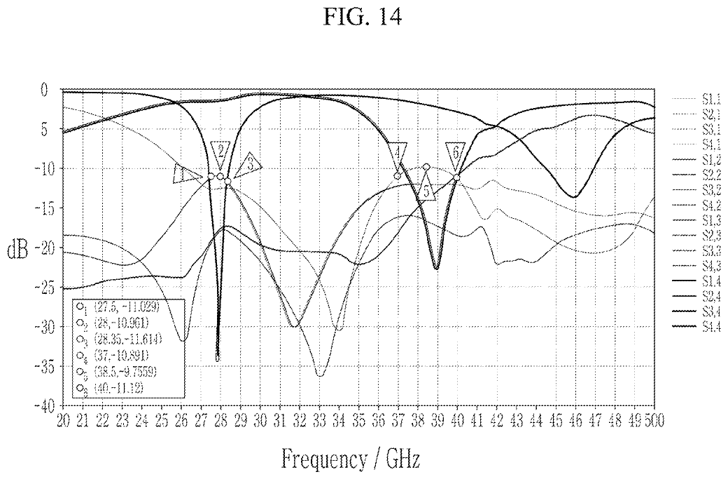

Results of an experimental example will now be described with reference to FIG. 14. FIG. 14 shows a graph of results of an experimental example.

According to the present experimental example, the antenna device 10000 according to an embodiment described with reference to FIG. 1 to FIG. 7 is formed, antenna isolations for respective frequencies are measured, and results are shown in the graph.

Referring to FIG. 14, the antenna device 10000 according to an embodiment may have the isolation of about −11.029 dB at the frequency of 27.5 GHz, the isolation of about −10.961 dB at the frequency of 28 GHz, and the isolation of about −11.614 dB at the frequency of 28.35 GHz.

The antenna device 10000 according to an embodiment may have the isolation of about −10.891 dB at the frequency of 37 GHz, the isolation of about −9.7559 dB at the frequency of 38.5 GHz, and the isolation of about −11.12 dB at the frequency of 40 GHz.

According to the antenna device according to the present embodiment, when a plurality of antenna patterns of the antenna are formed among the three insulation layers, it is found that the height of the antenna device is formed to be low and the isolation of the antenna device is −11 dB that is a high value.

Results according to another experimental example will now be described with reference to Table 1 and Table 2. Table 1 and Table 2 express results according to another experimental example.

In the present experimental example, as shown in FIG. 9 and FIG. 10, the antenna array 1000 including a plurality of antenna devices 10000 according to an embodiment is formed, antenna gains (realized gains) for respective frequencies are measured, and corresponding results are expressed in Table 1 and Table 2.

Table 1 expresses results of gains of a first frequency bandwidth, and Table 2 expresses results of gains of a second frequency bandwidth.

TABLE 1

Gains (dB) of first frequency bandwidth

| Frequency (GHz) | 27.5 | 28 | 28.35 | Average gain |
|---|---|---|---|---|
| Vertical | 9.03 | 9.65 | 9.55 | 9.41 |
| polarization | | | | |
| Horizontal | 8.75 | 9.25 | 9.23 | 9.08 |
| polarization | | | | |

TABLE 2

| | Gains (dB) of second frequency bandwidth | | | | | | | |
|---|---|---|---|---|---|---|---|---|
| Frequency (GHz) | 37 | 37.5 | 38 | 38.5 | 39 | 39.5 | 40 | Average gain |
| Vertical | 8.51 | 8.85 | 9.17 | 9.36 | 9.34 | 9.06 | 8.59 | 8.98 |
| polarization | | | | | | | | |
| Horizontal | 8.51 | 8.94 | 9.31 | 9.44 | 9.16 | 8.52 | 8.52 | 8.91 |
| polarization | | | | | | | | |

Referring to Table 1 and Table 2, it is found that the antenna array 1000 has the gain of equal to or greater than about 9 dB for the first frequency bandwidth and the gain of about 9 dB for the second frequency bandwidth. As described, it is found that the isolation characteristic of the antenna device according to the present embodiment is high, and the gain of the antenna array including an antenna device is high.

According to the antenna device according to the embodiments, the antenna size is reduced and the interference between the signals with different bandwidths may be reduced, thereby improving performance, and allowing down-sizing.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna device comprising:
a ground plane;
a first feed via and a second feed via for penetrating the ground plane through a first hole and a second hole of the ground plane;
a first feed pattern connected to the first feed via;
a first antenna pattern configured to be coupled to the first feed pattern and transmit/receive an RF signal of a first frequency bandwidth;
a second antenna pattern connected to the second feed via and configured to transmit/receive an RF signal of a second frequency bandwidth; and
a third antenna pattern disposed between the first antenna pattern and the second antenna pattern, and overlapping the first antenna pattern and the second antenna pattern.

2. The antenna device of claim 1, further comprising:
a first dielectric layer disposed between the first feed pattern and the first antenna pattern;
a second dielectric layer disposed between the first antenna pattern and the third antenna pattern;
a third dielectric layer disposed between the third antenna pattern and the second antenna pattern;
a first connection via penetrating through the first dielectric layer and connected to the second feed via;
a first connection pattern connected to the first connection via and disposed on the first dielectric layer;
a second connection via connected to the first connection pattern and penetrating through the second dielectric layer;
a second connection pattern connected to the second connection via and disposed on the second dielectric layer; and
a third connection via connected to the second connection pattern and the second antenna pattern and penetrating through the third dielectric layer.

3. The antenna device of claim 2, further comprising
a plurality of shield vias disposed between the first feed via and the second feed via.

4. The antenna device of claim 3, further comprising
a ground via penetrating through a center portion of the first antenna pattern and connected to the ground plane.

5. The antenna device of claim 4, further comprising
a metal pattern disposed on the third dielectric layer and connected to the ground via.

6. The antenna device of claim 5, wherein
the second antenna pattern comprises a hole in a center portion of the second antenna pattern, and
the metal pattern is disposed in the hole of the second antenna pattern.

7. The antenna device of claim 2, further comprising
a plurality of first parasitic patterns disposed on a side of an edge of the second antenna pattern,
wherein the first parasitic patterns do not overlap the first antenna pattern in a first direction from the ground plane to the first antenna pattern.

8. The antenna device of claim 7, further comprising
a plurality of second parasitic patterns disposed on a side of an edge of the third antenna pattern,
wherein the second parasitic patterns overlap the first parasitic patterns in the first direction.

9. The antenna device of claim 1, wherein
the second antenna pattern comprises a hole in a center portion, and further comprises a ground pattern connected to the ground plane and disposed in the hole.

10. The antenna device of claim 9, further comprising
a ground via penetrating through a center portion of the first antenna pattern and connected to the ground plane.

11. An antenna array, comprising:
array antenna devices disposed in an array; and
one or more shielding structures disposed at one or more of a first end of the array, a second end of the array, and alternately with two or more antenna array devices,
wherein one or more of the array antenna devices is the antenna device of claim 1.

12. An electronic device, comprising:
a set of the electronic device; and
the antenna array of claim 11 disposed on the set of the electronic device.

13. An antenna device comprising:
an antenna unit; and
a main circuit unit connected to the antenna unit through a connector,
wherein the antenna unit comprises:
a plurality of first dielectric layers;
a ground plane disposed below the first dielectric layers;
a first feed via and a second feed via penetrating a portion of the first dielectric layers;
a first antenna pattern disposed between the first dielectric layers and coupled to the first feed via to transmit/receive an RF signal of a first frequency bandwidth;
a second antenna pattern disposed between the first dielectric layers and connected to the second feed via to transmit/receive an RF signal of a second frequency bandwidth; and
a third antenna pattern disposed between the first antenna pattern and the second antenna pattern and overlapping the first antenna pattern and the second antenna pattern,
wherein the main circuit unit comprises:
a plurality of second dielectric layers; and
metal layers disposed between the second dielectric layers, and
wherein a loss tangent of the first dielectric layers is different from a loss tangent of the second dielectric layers.

14. The antenna device of claim 13, wherein
the first dielectric layers comprise:
a first dielectric layer disposed between the first feed pattern and the first antenna pattern;
a second dielectric layer disposed between the first antenna pattern and the third antenna pattern; and
a third dielectric layer disposed between the third antenna pattern and the second antenna pattern, and
the antenna unit further comprises:
a first connection via penetrating through the first dielectric layer and connected to the second feed via;
a first connection pattern connected to the first connection via and disposed on the first dielectric layer;
a second connection via connected to the first connection pattern and penetrating through the second dielectric layer;
a second connection pattern connected to the second connection via and disposed on the second dielectric layer; and
a third connection via connected to the second connection pattern and the second antenna pattern and penetrating through the third dielectric layer.

15. The antenna device of claim 14, wherein
the antenna unit further comprises a plurality of shield vias disposed between the first feed via and the second feed via.

16. The antenna device of claim 15, wherein
the antenna unit further comprises a ground via penetrating through a center portion of the first antenna pattern and connected to the ground plane.

17. The antenna device of claim 16, wherein
the antenna unit further comprises a metal pattern disposed on the third dielectric layer and connected to the ground via.

18. The antenna device of claim 17, wherein
the second antenna pattern comprises a hole in a center portion of the second antenna pattern, and
the metal pattern is disposed in the hole of the second antenna pattern.

19. The antenna device of claim 14, wherein
the antenna unit further comprises a plurality of first parasitic patterns disposed on a side of an edge of the second antenna pattern, and
the plurality of first parasitic patterns do not overlap the first pattern in a first direction from the ground plane to the first antenna pattern.

20. The antenna device of claim 19, wherein
the antenna unit further comprises a plurality of second parasitic patterns disposed on a side of an edge of the third antenna pattern, and
the plurality of second parasitic patterns overlap the first parasitic patterns in the first direction.

21. The antenna device of claim 13, wherein
the second antenna pattern comprises a hole in a center portion of the second antenna pattern, and
the antenna unit further comprises a ground pattern connected to the ground plane and disposed in the hole.

22. The antenna device of claim 21, wherein
the antenna unit further comprises a ground via penetrating through a center portion of the first antenna pattern and connected to the ground plane.

23. An antenna array, comprising:
array antenna devices disposed in an array; and
one or more shielding structures disposed at one or more of a first end of the array, a second end of the array, and alternately with two or more antenna array devices,
wherein one or more of the array antenna devices is the antenna device of claim 13.

24. An electronic device, comprising:
a set of the electronic device; and
the antenna array of claim 23 disposed on the set of the electronic device.

25. An antenna device comprising:
a first feed via connected to a first feed pattern;
a first antenna pattern disposed above the first feed pattern and configured to be coupled to the first feed pattern;
a second antenna pattern disposed above the first antenna;
connection vias connected to second and third feed vias, stepped apart from each other in two or more steps along connection patterns toward the second antenna pattern, and connected to the second antenna pattern; and
a third antenna pattern disposed between the first and second antenna patterns.

26. The antenna device of claim 25, further comprising shield vias disposed between the first feed via and the second and third feed vias.

27. The antenna device of claim 25, further comprising a ground via connected to a center portion of the first antenna pattern and connected to a ground plane.

28. The antenna device of claim 27, further comprising a metal pattern disposed on a same dielectric layer as the second antenna and connected to the ground via.

29. An antenna array, comprising:
array antenna devices disposed in an array; and
one or more shielding structures disposed at one or more of a first end of the array, a second end of the array, and alternately with two or more antenna array devices,
wherein one or more of the array antenna devices is the antenna device of claim 25.

30. An electronic device, comprising:
a set of the electronic device; and
the antenna array of claim 29 disposed on the set of the electronic device.
